(19) United States
(12) Patent Application Publication
(10) Pub. No.: US 2012/0143660 A1
(43) Pub. Date: Jun. 7, 2012

(54) INTERVAL BASED AD INSERTION USED FOR THE DELIVERY OF VIDEO STREAMS

(75) Inventors: Dai Jiwang, Princeton Junction, NJ (US); Ashwin Kashyap, Plainsboro, NJ (US); Jun Li, Indianapolis, IN (US)

(73) Assignee: THOMSON LICENSING, Boulogne-Billancourt (FR)

(21) Appl. No.: 12/737,176

(22) PCT Filed: Jun. 26, 2008
(86) PCT No.: PCT/US2008/008033

§ 371 Date: Oct. 27, 2011

(51) Int. Cl. G06Q 30/02

(52) U.S. Cl. 705/14.4

(57) ABSTRACT

The present principles provide a method and apparatus for performing time window based adaptive advertisement insertion into video on demand (VOD) programs. The method inserts advertisements dynamically according to the actual content viewing time, as opposed to the fixed advertisement insertion points in traditional ad insertion. The method minimizes the negative impact caused by inserted ads to viewers in interactive session, in which trick modes, such as fast forward and rewind are frequently used.

### BACKGROUND

1. Technical Field

The present principles relate to advertising. More particularly, they relate to time window based advertisement insertion into requested video programming.

2. Description of the Related Art

Video on demand programs provide users with the ability to pause, fast forward, rewind, skip over segments of programming, and to randomly select video content using control commands. Traditional ad insertion techniques, which are based on a few fixed insertion points between video segments as used for broadcast programming, do not work well for on-demand programming. For example, if a user operated a trick play function while viewing on-demand programming, the user would skip through ad insertion points and therefore avoid ads. From an advertiser's standpoint this is troublesome because ads which the advertiser purchased are not shown.

Some service providers address this skipping problem by forcing users to view advertisements by prohibiting ad skipping at the video server side. Hence, video programming can be reversed or fast forwarded through programming events, but a user is forced to watch commercials during advertisement breaks in programming because such trick play features are inactivated for the duration of the inserted commercial break.

### SUMMARY

According to one aspect of the present principles, the method for displaying a message includes determining whether a playback device is in an active mode for a time window having a predetermined time window criteria, wherein the time window does not include the period of time when the playback device is in an inactive mode, identifying possible message insertion points in a multimedia stream when the time window criteria has been met, and inserting a first message into the multimedia stream at the message insertion point that follows the meeting of the time window criteria.

The active mode can include, for example, playing the multimedia stream at normal speed, and the inactive mode can include a trick mode of operation of the playback device. The trick mode or inactive mode can be, for example, any one of pausing playback of the multimedia stream, fast forwarding (1×, 2×, 4×, etc.) the multimedia stream, rewinding playback (1×, 2×, 4×, etc.) of the multimedia stream and slow motion playback of the multimedia stream. Those of ordinary skill will recognize that the actions that constitute active and inactive mode can be changed without departing from the spirit of the present principles. For example, the active and inactive modes can be determined by a service operator and can differ between service operators.

The predetermined time window criteria can be a predetermined amount of time within which no message is to be displayed to a user.

According to another aspect, the method includes restarting the time window after the step of inserting, and repeating the steps of determining, identifying and inserting for a next message to be displayed to the user. In this implementation, the time between the display of the first message and the display of the next message to the user is substantially equal to the time window period of time for the active mode of the playback device.

According to yet another aspect, the method can further include marking the multimedia stream with potential message insertion points prior to broadcasting the same to the user, and can further include receiving a message insertion request before the steps of determining, identifying and inserting. In yet another implementation, the method can further include ignoring additional message insertion requests until the steps of determining, identifying and inserting are performed for the received message insertion request.

The multimedia stream on which the present principles can be applied can be, for example, a television program, an audio program, a radio program, a video game, a movie, streaming audio, streaming video, a mobile video program, a mobile audio program and video on demand (VOD) programming. Other multimedia streams can also be included in this list to which the present principles can be applied.

In accordance with another aspect, the inserted message can be a static advertisement, an active advertisement, and/or a combination of one or more of the above.

According to a further implementation, the apparatus includes a processor, a storage device in communication with the processor such that the processor and storage device cooperate to provide a multimedia stream to an end user, and means for inserting messages into the multimedia stream. The inserting means includes configuring the processor to determine when the multimedia stream is active for a period of time defined by a time window, and inserting the message into the multimedia stream when time window criteria has been satisfied. According to one implementation, the time window does not include time that elapses when the multimedia stream is inactive.

According to one implementation, the inserting means includes an ad insertion server in communication with the processor and the storage device, and the processor and storage device make up part of a program stream server. According to another implementation, the insertion means cane includes an ad insertion server integrated within the program stream server.

The program stream server can include a trick mode detector configured to detect trick mode operation of the multimedia stream, and a counter configured to monitor the time window of the active playback of the multimedia stream.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is block diagram of an end to end ad insertion system;

FIG. 2a is a diagrammatic representation of a linear based ad insertion method of the prior art;

FIG. 2b is a diagrammatic representation of the time window based ad insertion according to an implementation of the present principles;

FIG. 3a is a flow diagram of the method for dynamic ad insertion according to an implementation of the present principles;

FIG. 3b is a flow chart of the method for time window based ad insertion according to an implementation of the present principles; and

FIG. 4 is a block diagram of an ad insertion system according to an implementation of the present principles.

### DETAILED DESCRIPTION

This present principles propose a ad insertion method and apparatus which dynamically inserts advertisements based on the elapsed time that the user actually views the content. The elapsed time does not count the time that a user spends in trick modes, e.g. pause, fast forward or rewind. When the elapsed time crosses a preset threshold, ad programs (i.e., advertisements in any suitable audio/video form) will be inserted at a proper time such as the closest pre-designated insertion point. Since ads are only presented to users after they view significant amount time of regular programs, the negative impact to users would be minimal even if the video server does not allow users to skip ads. Therefore the method of the present principles increases the chance that ad programs are delivered to viewers.

According to one implementation of the present principles, the ad-insertion device is incorporated into the Internet protocol TV (IPTV) video on demand (VOD) system. According to another implementation, the ad-insertion server can be incorporated into a video-rich web server or video search engine.

In the description of the invention, the term “time window” is representative of a time interval which is increased in value (typically by a time unit such as seconds). The time window or time interval will be increased when video programming is in an “active mode”, or a non-trick play mode. Typically, an active mode is associated with the viewing of video programming in a real time fashion (neither speed up or slowed down). The time window or time interval will not be increased when in an “inactive mode” which is when video programming is being subjected to a trick play function such as skipping, fast forwarding video programming, or reversing video programming.

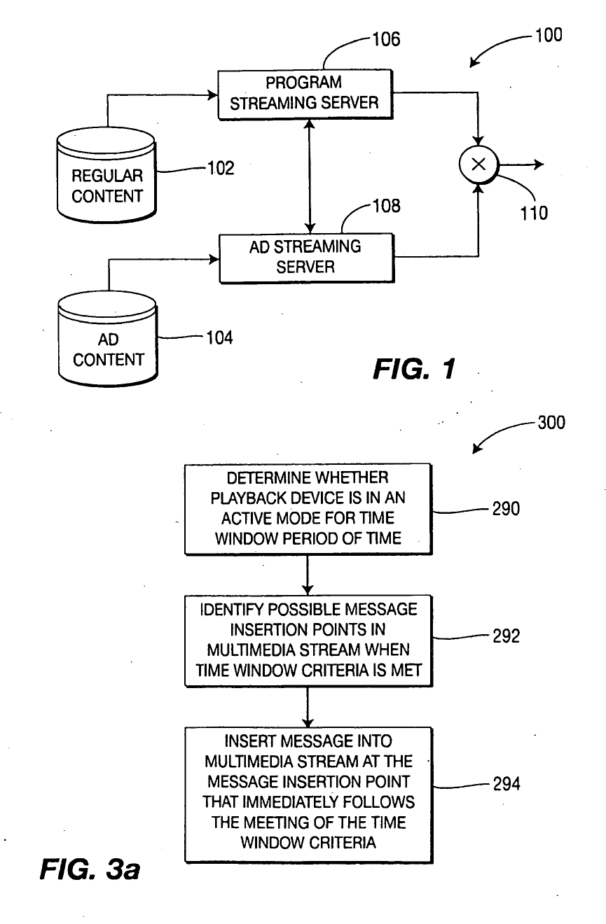

FIG. 1 shows the end-to-end ad insertion system according to an implementation of the present principles. The program streaming server 106 streams regular content 102 and sends ad insertion requests to the ad streaming server 108 when it detects the event for ad insertion. The ad streaming server 108 streams ad content 104 when it gets the request from the video (program) stream server 106 and sends the notification back when the ad insertion is completed. In the video on demand (VOD) system, the video stream server 106 and ad insertion server 108 can be combined into one server, although multiple servers can be used to deliver programming and advertisements.

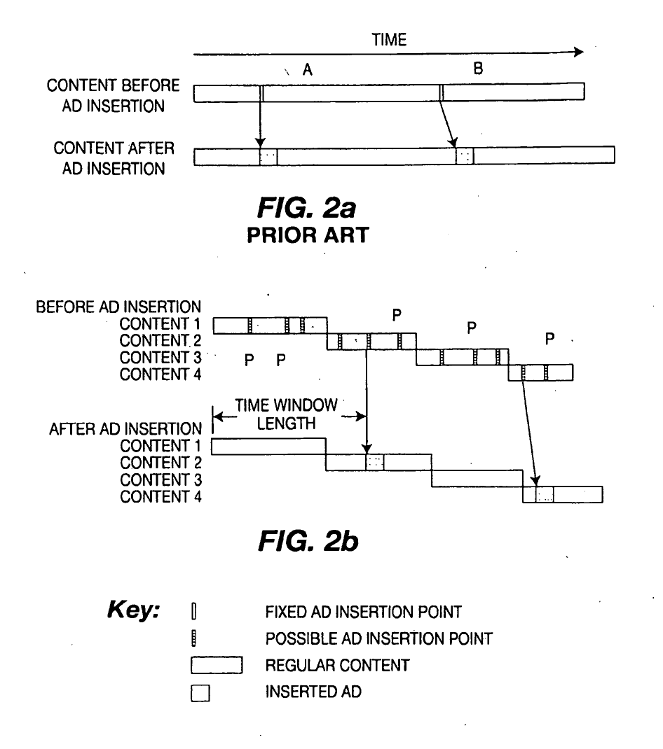

FIGS. 2a and 2b provide a diagrammatic explanation of the time window based ad insertion system of the present principles. FIG. 2a shows traditional linear ad insertion, in which the ads are inserted into fixed ad insertion points A and B in a linear program.

FIG. 2b shows the new ad insertion scheme according to an implementation of the present principles. All possible ad insertion points P in each program are pre indexed. One aspect of the present method is to mark much more possible ad insertion points P in the program than the actual insertion points. Only those possible ad insertions points P that meet the time window criteria will become the actual insertion points during streaming. Hence, a number of possible ad insertion points P will not be used, and it will only be the possible ad insertion point that follows after a time window criteria is met, for example after ten minutes of viewing program, the closest possible ad insertion point P after that time period will be used for actual ad insertion.

An aspect of the invention appreciates that that the artistic integrity of a video program should be preserved, where the insertion of ad insertion points P can be implemented at fixed time periods. Such an approach can be improved by manually specifying where such insertion points P are to be in video programming. With the enormous amount of video content available however, it can be difficult to have such ad insertion points P be manually defined for every piece of video content. Hence, optional embodiments of this invention provide for the generation of ad insertion points P to be done automatically.

One possible approach for automatically generating ad insertion P is to have a server 106 analyze attributes of the video programming that it delivers. For example, the video programming can make use of splicing points. Alternatively, the server 106 can apply a technique to identify a scene change which can be identified by a fade in, fade out, quick video cut, a scene change flag which is in the bit stream, or other approach consistent with these principles. Additionally, an ad insertion P can be noted by analyzing the metadata associated with a stream, where a change in the metadata would possibly indicate a potential ad insertion point P.

In order to stem the possibility that the identification of potential ad insertion points becomes too frequent, a limiting condition can be imposed which would reduce the overall automatically identified number ad insertion points P. For example, this limiting condition can set a maximum number of identified ad insertion points P for a selected time period. Additionally, multiple criteria can be utilized to provide a ranking for identified ad insertion points P. For example, an ad insertion P identified in view of a fade out sequence can be given more weight than an ad insertion P which was identified because of a change in metadata. Other approaches can be implemented in accordance with these principles.

It is also recognized that a user can switch between different content streams (e.g., content 1, content 2, content 3, content 4, etc. in FIG. 2b) during a time window. The present principles will still apply the same methodology of inserting and displaying an ad after the respective time window criteria has been met. The ad insertion point selected will be dependent on the point P that is available in the content currently being viewed or listened to, as shown in FIG. 2b.

During real-time streaming, programs are accessed in a random fashion. Content 1-4 illustrates the scenario where multiple content streams are accessed in a real-time streaming session. In the real application, content 1-4 can be different chapters of the same movie, different movie title or different news clips, etc. Therefore, the possible ad insertion points P in this example appear to arise at random times, although this is not the case because a user viewing such programming will probably switch between different streams video streams. The time window process only enables those ad insertion points that are separated by the pre-defined time window. The time elapsed when operating the playback device in a trick mode or during the actual ad insertion is excluded from the time window or time interval.

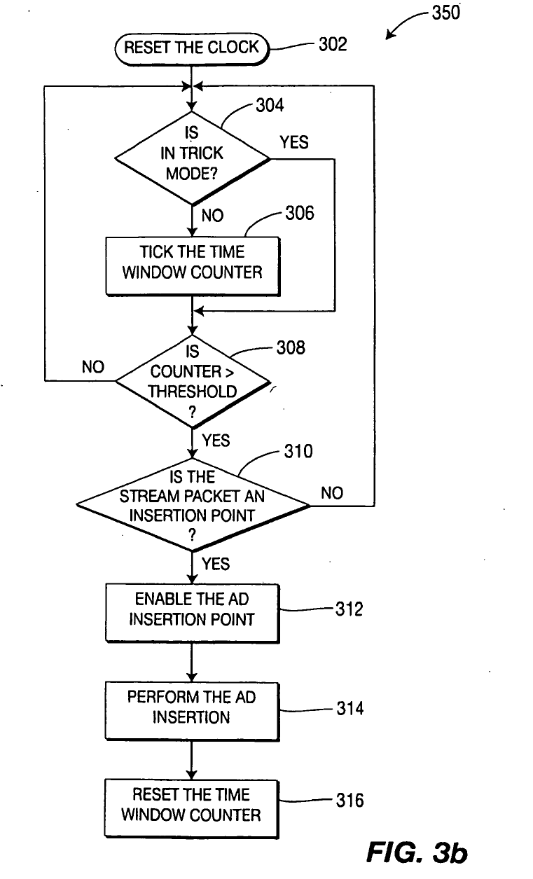

FIG. 3a shows a high level flow diagram of the method 300 for dynamic ad insertion according to an implementation of the present principles. Initially, a determination is made as to whether the multimedia stream is in an active mode for a period of time defined by the time interval corresponding to a time window (290). Generally, the active mode is one defined by normal playback of the multimedia stream by the playing device. The playing device can be, for example, a set top box with VOD capability, a computer, a DVD player, other video/audio On-demand capable playback device, or a playback device utilizing a streaming media playback program such as QUICKTIME™, WINDOWS MEDIA PLAYER™, REAL PLAYER™, FLASH™, and the like.

During the playing of the multimedia stream, one or more insertion requests can be received or defined. In response, the system identifies possible message insertion points in the multimedia stream when the time window criteria has been met (i.e., the time period for active play mode has elapsed)—292. The message is the inserted into the first identified possible message insertion point that occurs in the multimedia stream after meeting the timing criterion of the established time window. That is, a time interval is associated with the time window, where time interval is increased in value during the time when video is watched in a normal or real-time viewing mode. The time interval will not be incremented when video is in a trick-play mode. Hence, the timing criterion is a predetermined time value, such as five minutes, ten minutes, and the like. A comparison is performed to determine whether the length of time of the time interval exceeds the predetermined time value. If the time interval does exceed the predetermined time value, a message will be inserted into the first identified possible message insertion point. If the time interval is less than the predetermined time interval, a message will not be inserted and the time interval associated with the time window will continually be incremented.

FIG. 3b shows a more detailed flow chart of method for dynamic ad insertion 350 according to an implementation of the present principles. Initially a clock or time keeping counter associated with a time interval is reset 302, and a determination is made (304) whether the playback device is in a trick mode (i.e., playback of the stream is considered inactive when operating in a trick mode). When not in trick mode, the time window counter associated with a time interval continues to be ticked/incremented (306). When in trick mode at step 304, the time ticking of the time window counter is skipped and the determination as to whether or not the time window counter has exceeded a predetermined threshold time (308). The predetermined threshold time can be user configurable and saved into a configuration file, or can be preset by a manufacturer or information/service provider. If the threshold is not exceeded (308), the process loops back to the monitoring of the trick mode (304) and ticking of the time window counter (306) until the counter threshold is met.

Once the threshold is met at step 310 where the amount of time associated with a time interval exceeds the threshold, a determination (310) is made as to whether the stream packet has a possible ad insertion point. If not, the process loops back to the trick mode monitoring 304 and time window ticking 306. If there is a possible ad insertion point in the stream packet, ad insertion point is enabled 312, and an ad insertion is performed 314 at that point where the ad insertion point is the ad insertion point that is encountered first in said stream packet. Once completed, the time window counter associated with the time interval is reset and the system is now ready to repeat the ad insertion process 300.

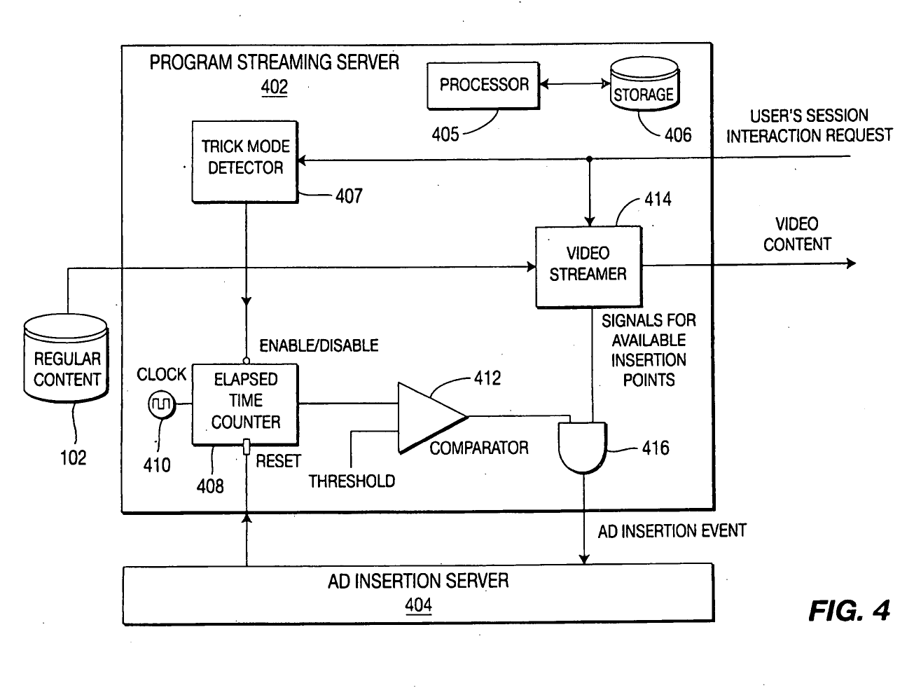

FIG. 4 shows a detailed block diagram of the ad insertion system 400 according to an implementation of the present principles. The video streamer 414 of the program streaming server 402 streams the on-demand regular program content 102 to the end users according to users' session interaction requests, such as play, pause, rewind, fast forward, etc. The video streamer 414 also detects the ad insertion points in the regular program content 102. Those of ordinary skill should recognize that the user is generally playing the video stream through a playback device, such as, for example, a set top box with VOD capability, a computer, or other video/audio On-demand capable playback device. The Program streaming server generally includes a processor 405 and a storage device 406 (e.g., RAM, ROM, hard disk, or other suitable memory storage) for storing program commands for execution by the processor. Although not explicitly shown, it should be understood that the processor 405 is in communication with all components contained within the program streaming server 402.

The elapsed time counter 408 keeps track of the elapsed time during play mode. The trick modes (pause, fast forward and rewind, etc.) as implemented by the trick mode detector 407 operate to disable the counter 408 so the counter is able to exclude the time (from the time window) that a user spends in any given trick mode. If the elapsed time passes a certain pre-defined threshold as determined by the comparator 412, any possible ad insertion point detected by the program streamer will induce an ad insertion signal being sent to the ad insertion server 404 to trigger an ad insertion event. In one implementation, the ad insertion server 404 and the program streaming server 402 are implemented in a single server device.

Upon receiving the ad insertion request, the ad insertion server 404 will perform the ad insertion. Once the ad insertion is started, further ad insertion requests will be ignored by the ad insertion server until the current insertion is completed. Upon completion, the ad insertion server will send a reset signal back to the elapsed time counter 408 to clear or reset the counter value to zero so the counter will start again to count the elapsed time for active mode operation during the time window.

Implementations of the various processes and features described herein can be embodied in a variety of different equipment or applications, particularly, for example, equipment or applications associated with data transmission and reception. Examples of equipment include video coders, video decoders, video codecs, web servers, set-top boxes, laptops, personal computers, and other communication devices. As should be clear, the equipment can be mobile and even installed in a mobile vehicle.

Additionally, the methods can be implemented by instructions being performed by a processor, and such instructions can be stored on a processor-readable medium such as, for example, an integrated circuit, a software carrier or other storage device such as, for example, a hard disk, a compact diskette, a random access memory (“RAM”), or a read-only memory (“ROM”). The instructions can form an application program tangibly embodied on a processor-readable medium. As should be clear, a processor can include a processor-readable medium having, for example, instructions for carrying out a process.

A number of implementations have been described. Nevertheless, it should be understood that various modifications can be made. For example, elements of different implementations can be combined, supplemented, modified, or removed to produce other implementations. Additionally, one of ordinary skill will understand that other structures and processes can be substituted for those disclosed and the resulting implementations will perform at least substantially the same function(s), in at least substantially the same way(s), to achieve at least substantially the same result(s) as the implementations disclosed. Accordingly, these and other implementations are within the scope of the following claims.

1. A method for displaying a message comprising the steps of:
determining whether a playback device is in a first mode, where a time interval is incremented during this first mode, wherein the time interval will not be incremeneted when the playback device is in a second mode associated with a trick play function;
identifying an message insertion point in a multimedia stream when a time value associated with the time interval is at least one of: equal to a threshold value and exceeds said threshold value; and
inserting a first message into the multimedia stream at a message insertion point that follows when said time value interval is at least one of: equal to said threshold value and exceeds said threshold value.

2. The method of claim 1, wherein the time interval comprises an amount of time within which no message is to be displayed to a user.

3. The method of claim 1, further comprising:
restarting the time interval after said step of inserting; and
repeating said steps of determining, identifying and inserting for a next message to be displayed to the user, wherein the time between the display of the first message and the display of the next message to the user is substantially equal to the time interval for the first mode of the playback device which is a non-trick playback mode.

4. The method of claim 1, further comprising automatically marking the multimedia stream with message insertion points prior to broadcasting said multimedia stream.

5. The method of claim 1, wherein said steps of determining, identifying and inserting are performed during real time viewing by the user.

6. The method of claim 1, further comprising receiving a message insertion request before said steps of determining, identifying and inserting.

7. The method of claim 6, further comprising ignoring additional message insertion requests until said steps of determining, identifying and inserting are performed for the received message insertion request.

8. The method of claim 1, wherein the multimedia stream comprises one selected from a group consisting of a television program, an audio program, a radio program, a video game, a movie, streaming audio, streaming video, a mobile video program, a mobile audio program and video on demand (VOD) programming.

9. An apparatus comprising:
a processor;
a storage device in communication with the server, the processor and storage device cooperating to provide a multimedia stream to an end user;
an inserter that places messages into the multimedia stream, said inserting means including configuring the processor to determine when the multimedia stream is active for a period of time defined by a time interval which is associated with a non-trick playback mode, and inserting the message into the multimedia stream when period of time associated with the time interval meets a threshold value; wherein the time interval is not incremented when the multimedia stream is subject to a trick mode operation.

10. The apparatus of claim 9, wherein the time interval comprises an amount of time in which no advertising message has been displayed to the user.

11. The apparatus of claim 9, wherein the inserter comprises an ad insertion server in communication with the processor and the storage device.

12. The apparatus of claim 9, wherein processor and storage device make up part of a program stream server, and the inserter comprises an ad insertion server integrated within the program stream server.

13. The apparatus of claim 12, wherein the program stream server further comprises:
a trick mode detector configured to detect trick mode operation of the multimedia stream; and
a counter configured to monitor the time interval of the active playback of the multimedia stream.

14. A computer program product comprising a computer useable medium having computer readable program code embodied thereon for use in a video encoder, the computer program product comprising:
program code for determining whether a playback device is in an active mode for a time window having a predetermined time window criteria, wherein the time window does not include time when the playback device is in an inactive mode;
program code for identifying possible message insertion points in a multimedia stream when the time window criteria has been met; and
program code for inserting a first message into the multimedia stream at the message insertion point that immediately follows the meeting of the time window criteria.

15. The computer program product of claim 14, further comprising:
program code for restarting the time window after said set of inserting; and
program code for repeating said steps of determining, identifying and inserting for a next message to be displayed to the user, wherein the time between the display of the first message and the display of the next message to the user is substantially equal to the time window period of time for the active mode of the playback device.

16. The computer program product of claim 15, further comprising program code for receiving a message insertion request before said steps of determining, identifying and inserting.

17. A method for displaying an advertising message, comprising the steps of:
initiating a time interval during normal playback of a multimedia stream, wherein a time value associated with said time interval is only incremented during said normal playback of said multimedia stream;
comparing said time value to a threshold, wherein an advertising message is inserted into said multimedia stream in an occurred message insertion point occurred when said time value meets said threshold.

18. The method of claim 17, further comprising the steps of
initiating a further time interval upon the insertion of said advertising message;
incrementing said further time interval during normal playback of said multimedia stream but said incrementing operation is not performed when said multimedia stream is subject to a trick play mode;
inserting a second advertising message into said multimedia stream in a second occurred message insertion point when said time value meets said threshold.

19. The method of claim 17, further comprising the step of inserting said advertising message into said multimedia stream at the first one of said message insertion points that occurs after said time value is at least one of: meets said threshold and exceeds said threshold.
